(19) United States
(12) Patent Application Publication
(10) Pub. No.: US 2018/0132266 A1
(43) Pub. Date: May 10, 2018

(54) METHOD AND APPARATUS FOR TRANSMITTING CONTROL INFORMATION IN A WIRELESS COMMUNICATION SYSTEM

(71) Applicant: ASUSTek Computer Inc., Taipei City (TW)

(72) Inventors: Wei-Yu Chen, Taipei City (TW); Li-Chih Tseng, Taipei City (TW); Hsin-Hsi Tsai, Taipei City (TW)

(21) Appl. No.: 15/803,068

(22) Filed: Nov. 3, 2017

Related U.S. Application Data
(60) Provisional application No. 62/417,723, filed on Nov. 4, 2016.

(51) Int. Cl. H04W 72/12; H04W 28/06; H04L 12/873; H04L 12/863; H04W 72/04

(52) U.S. Cl. CPC H04W 72/1278; H04W 72/1284; H04W 72/0406; H04L 47/522; H04L 47/626; H04W 28/065

(57) ABSTRACT

A method and apparatus are disclosed from the perspective of a UE. In one embodiment, the method includes triggering a MAC control information, wherein the MAC control information is linked to a specific set of scheduling unit(s). The method further includes determining a transmission opportunity based on an uplink grant. The method also includes using the transmission opportunity to transmit a first packet that includes the MAC control information to a base station if the uplink grant belongs to the specific set of scheduling unit(s). In addition, the method includes using the transmission opportunity to transmit a second packet that does not include the MAC control information to the base station if the uplink grant does not belong to the specific set of scheduling unit(s).

### CROSS-REFERENCE TO RELATED APPLICATIONS

The present Application claims the benefit of U.S. Provisional Patent Application Ser. No. 62/417,723 filed on Nov. 4, 2016, the entire disclosure of which is incorporated herein in its entirety by reference.

### FIELD

This disclosure generally relates to wireless communication networks, and more particularly, to a method and apparatus for transmitting control information in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a UE. In one embodiment, the method includes triggering a MAC (Medium Access Control) control information, wherein the MAC control information is linked to a specific set of scheduling unit(s). The method further includes determining a transmission opportunity based on an uplink grant. The method also includes using the transmission opportunity to transmit a first packet that includes the MAC control information to a base station if the uplink grant belongs to the specific set of scheduling unit(s). In addition, the method includes using the transmission opportunity to transmit a second packet that does not include the MAC control information to the base station if the uplink grant does not belong to the specific set of scheduling unit(s).

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of a figure of 3GPP R1-168140 (RAN1#86 Chairman's Notes).

FIG. 6 is a diagram according to one exemplary embodiment.

FIG. 7 is a diagram according to one exemplary embodiment.

FIG. 8 is a diagram according to one exemplary embodiment.

FIG. 9 is a diagram according to one exemplary embodiment.

FIG. 10 is a diagram according to one exemplary embodiment.

FIG. 11 is a diagram according to one exemplary embodiment.

FIG. 12 is a diagram according to one exemplary embodiment.

FIG. 13 is a diagram according to one exemplary embodiment.

FIG. 14 is a diagram according to one exemplary embodiment.

FIG. 15 is a diagram according to one exemplary embodiment.

FIG. 16 is a diagram according to one exemplary embodiment.

FIG. 17 is a flow chart according to one exemplary embodiment.

FIG. 18 is a flow chart according to one exemplary embodiment.

FIG. 19 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including: TR 38.913 V0.3.0, “Study on Scenarios and Requirements for Next Generation Access Technologies”; RAN1#86 Chairman's Notes; Final Report of 3GPP TSG RAN WG1 #85 v1.0.0; Final Report of 3GPP TSG RAN WG1 #84 v1.0.0; Final Report of 3GPP TSG RAN WG1 #86bis; TS 36.321 v14.0.0, “E-UTRA; Media Access Control (MAC) Protocol specification (Release 14)”; and TS 36.331 v14.0.0, “E-UTRA; Radio Resource Control (RRC) Protocol specification (Release 14)”. The standards and documents listed above are hereby expressly incorporated by reference in their entirety.

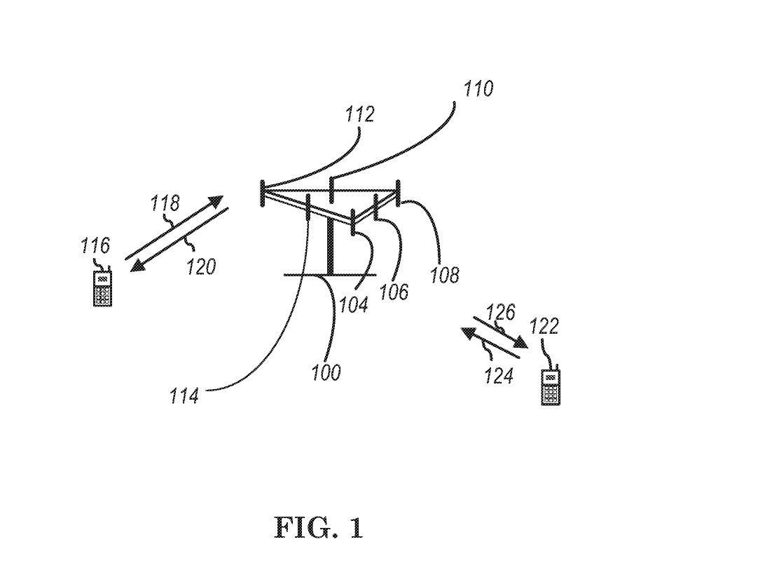

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

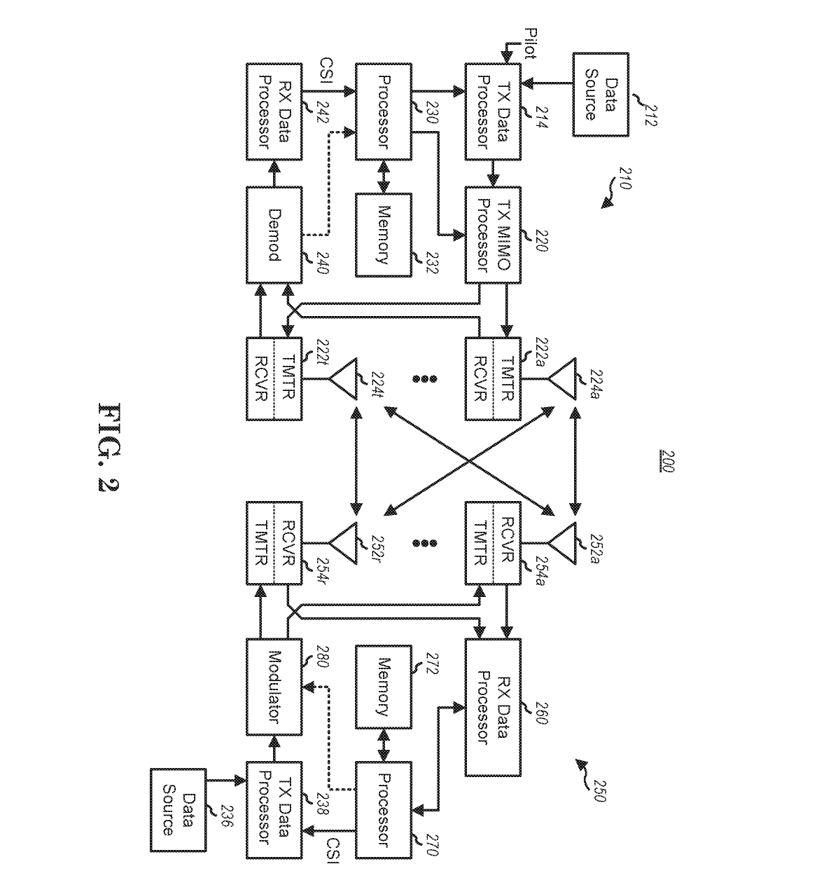

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

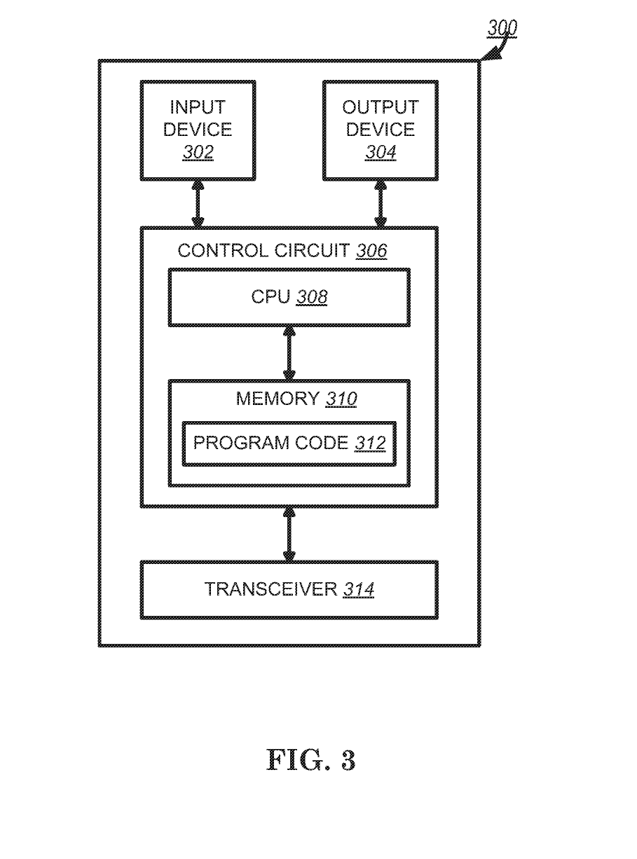

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

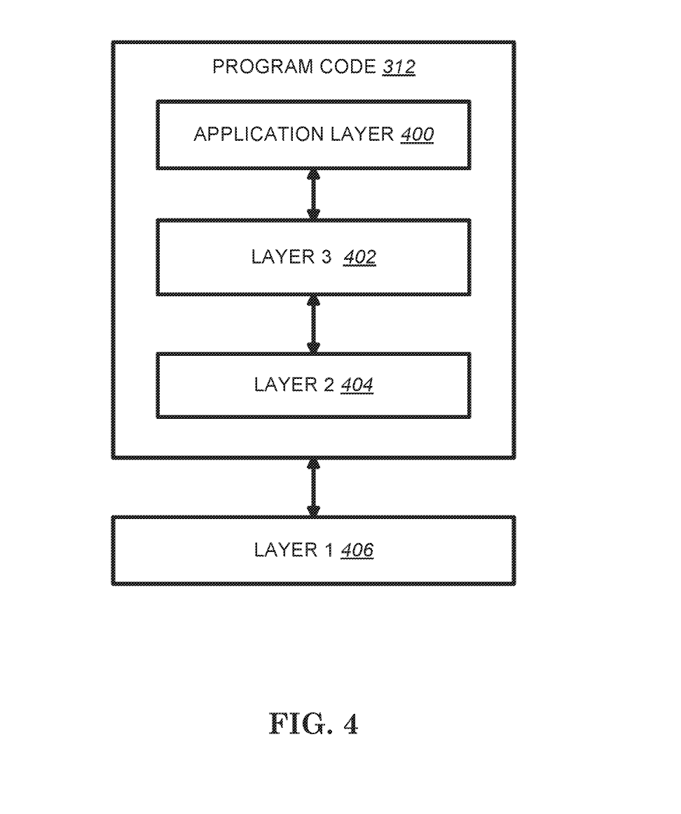

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

The general objective of this invention is to study the frame structure used in New RAT (NR) for 5G, to accommodate various type of requirement (as discussed in 3GPP TR 38.913) for time and frequency resource, e.g., from ultra-low latency (˜0.5 ms) to expected longer TTI (Transmission Time Interval) for MTC (Machine Type Communication), from high peak rate for eMBB (enhanced Mobile Broadband) to very low data rate for MTC. An important focus of this invention is low latency aspect, while other aspect of mixing/adapting different TTIs can also be considered in the study. In addition to diverse services and requirements, forward compatibility is an important consideration in initial NR frame structure design as not all features of NR would be included in the beginning phase/release.

As discussed in 3GPP RAN1#86 Chairman Notes, 3GPP Final Report of 3GPP TSG RAN WG1 #85 v1.0.0, 3GPP Final Report of 3GPP TSG RAN WG1 #84 v1.0.0, and 3GPP Final Report of 3GPP TSG RAN WG1 #86bis, in current RAN1's progress, there are some agreements related to radio resource for scheduling as follows:

### Agreements:

For the study of NR, RAN1 assumes that multiple (but not necessarily all) OFDM numerologies can apply to the same frequency range
   Note: RAN1 does not assume to apply very low value of subcarrier spacing to very high carrier frequency

### Agreements:

For a NR carrier (from network perspective) using multiple numerologies, at least the following is for further study
multiple frequency/time portions using different numerologies share a synchronization signal
Note: The synchronization signal refers to the signal itself and the time-frequency resource used to transmit the synchronization signal

### Working Assumption

RAN1 concludes on alternative 1 (15 kHz) as the baseline design assumption for the NR numerology
RAN1 concludes on scale factors N=2ⁿ for subcarrier spacing as the baseline design assumption for the NR numerology.

### Agreements:

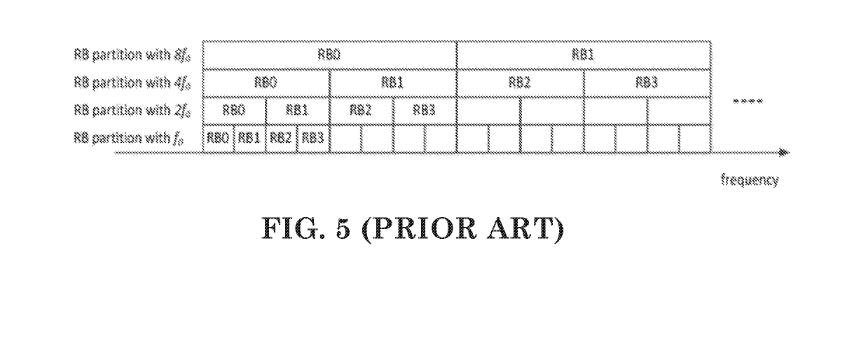

In one carrier when multiple numerologies are time domain multiplexed [as shown in FIG. 5],
   RBs for different numerologies are located on a fixed grid relative to each other
   For subcarrier spacing of 2ⁿ*15 kHz, the RB grids are defined as the subset/superset of the RB grid for subcarrier spacing of 15 kHz in a nested manner in the frequency domain
   Note that following numbering in the figure is just an example
   FFS: frequency domain multiplexing case

### Agreements:

Followings are considered as starting points of NR frame structure at least within the CP overhead
   Subframe
      Already agreed upon
      Assume x=14 in the reference numerology for subframe definition (for normal CP)
      FFS: y=x and/or y=x/2 and/or y is signaled
   Slot
      Slot of duration y OFDM symbols in the numerology used for transmission
      An integer number of slots fit within one subframe duration (at least for subcarrier spacing is larger than or equal the reference numerology)
      The structure allows for ctrl at the beginning only
      The structure allows for ctrl at the end only
      The structure allows for ctrl at the end and at the beginning
      Other structure is not precluded
      One possible scheduling unit
   Mini-slot
      Should at least support transmission shorter than y OFDM symbols in the numerology used for transmission
      May contain ctrl at the beginning and/or ctrl at the end
      The smallest mini-slot is the smallest possible scheduling unit (FFS: smallest number of symbols)
   Note: the names are for the purpose of discussion. Whether some terms can be merged or not is FFS
      FFS whether NR frame structure needs to support both slot and mini-slot or these can be merged

### Agreements:

Sub-frame duration is fixed to 1 ms
Reference numerology for defining subframe duration is 15 kHz

### Working Assumptions:

The NR frame structure should support both slots and mini-slots
   FFS: Timeline granularity for monitoring control of the mini-slot
   FFS: Terminologies of mini-slot

### Agreements:

Slot aggregation is supported
Data transmission can be scheduled to span one or multiple slots

3GPP TS 36.321v14.0.0 includes detail procedures and designs of control information in MAC (Medium Access Control) layer (e.g., BSR (Buffer Status Report) control element, PHR (Power Headroom Report) control element, SPS (Semi Persistent Scheduling) confirmation control element, etc.). Furthermore, 3GPP TS 36.331 v14.0.0 includes detail configuration for supporting control information in MAC layer.

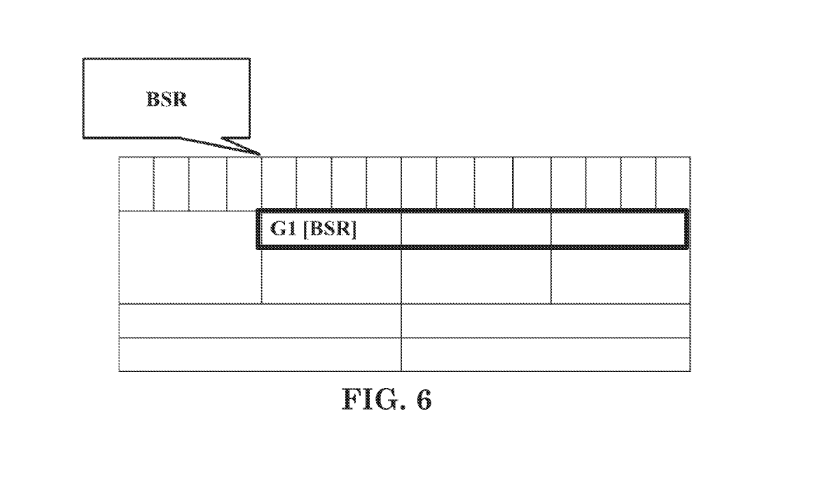

In LTE, when a UE receives an uplink grant and a control element (e.g., BSR, PHR, etc.) is triggered, the UE will directly include the control element and cancelled the corresponding trigger. FIG. 6 illustrates an exemplary legacy behavior for a UE having an uplink grant (i.e., G1) when a BSR is triggered. As shown in FIG. 6, the BSR will be included into transmission of G1 and the triggered BSR will be cancelled.

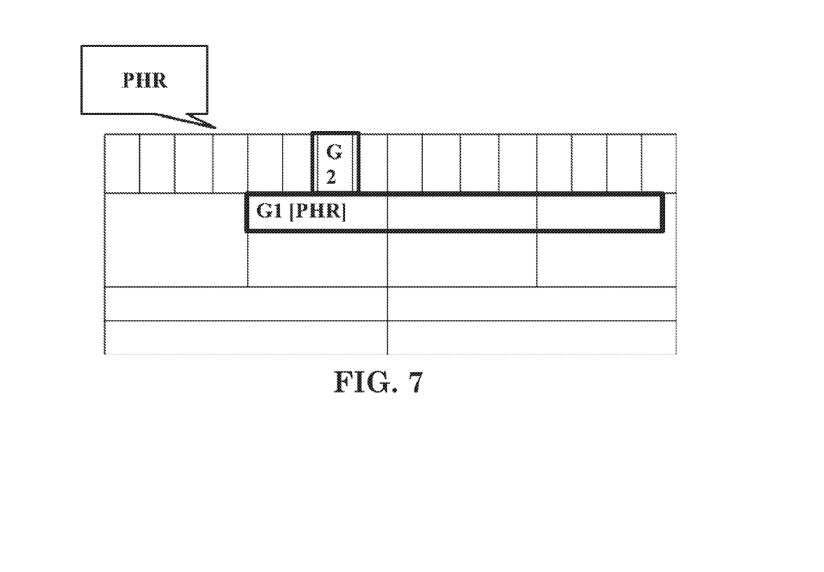

FIG. 7 shows an exemplary legacy behavior for a UE having uplink grants (i.e., G1 and G2) when a BSR is triggered. In FIG. 7, since a PHR is triggered before the transmission of first uplink grant (i.e., G1) and the transmission of second grant (i.e., G2) following legacy design, the UE will include the PHR will be included into transmission of G1 instead of transmission of G2.

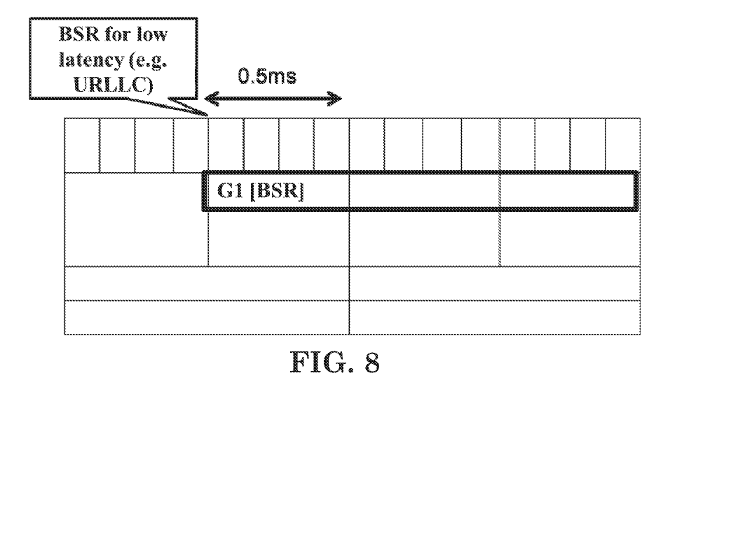

However, there may be some problems in the NR system. One possible issue could be that BSR delay causing latency requirement of some services cannot be met. FIG. 8 shows an example of the issue. As shown in FIG. 8, the latency requirement of the URLLC (Ultra-Reliable and Low Latency Communications) service is 1 ms. In the example, since BSR will be received by NW (Network) after 1.5 ms, NW cannot schedule another uplink grant to transmit URLLC data. Also, the URLLC data cannot be carried by transmission of the uplink grant (i.e., G1) due to latency requirement.

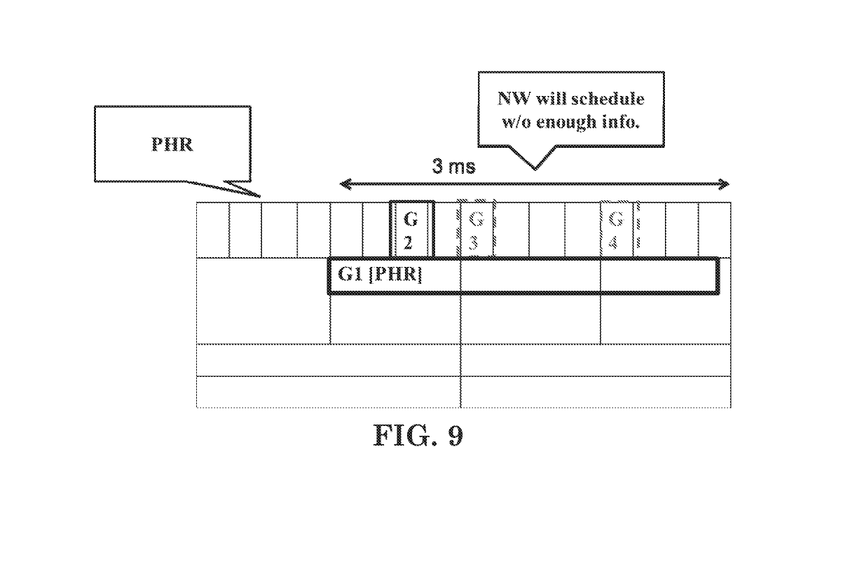

Another possible issue could be that when a PHR is transmitted through a long TTI uplink grant with eMBB or mMTC data for short scheduling unit (e.g., large Sub-Carrier Spacing (SCS)), NW will need to schedule without latest UE power information. In such case, NW may need to conservatively schedule for low latency services (e.g., gaming, URLLC, TCP (Transmission Control Protocol), etc.). FIG. 9 illustrates a possible example. In the case shown in FIG. 9, if NW would like to schedule G2, G3, and G4 for low latency service (e.g., URLLC, gaming, VoIP (Voice Over IP), TCP, etc.), insufficient information may limit or degrade transmissions of G2, G3, and G4.

Possible solutions to solve the above issues are discussed below.

Solution 1—The general concept of solution 1 is to associate control information of MAC layer (i.e., MAC control element) with scheduling resource with a limitation (e.g., within certain time scale or with special set of scheduling resource). Based on the limitation, the control information of MAC layer will not be transmitted through inappropriate uplink grant.

In one embodiment, the scheduling resource limitation for the control information could be linking the control information to (i) a range of TTIs or a specific TTI (e.g., 0.125 ms˜0.5 ms, 0.0625 ms), (ii) a set of numerology (sub-carrier spacing) (e.g., specific numerology or some specific numerologies), (iii) a range of symbols on specific numerology or some specific numerologies, or (iv) certain scheduling unit(s) (e.g., slot, mini-slot, etc.) on specific numerology or some specific numerologies.

In one embodiment, the scheduling resource limitation for the control information could also be linking the control information to resource on specific physical channel. The physical channel will not be used to transmit user data from logical channel. The physical channel may be used to transmit only control information.

In one embodiment, the scheduling resource limitation for the control information could be linking the control information to resource on specific set of cell(s) or specific set of TRP(s) or specific set of network beam(s), or to specific semi-persistently scheduling (SPS) resource (e.g., UE has multiple activated SPS resource and UE's control information is linked to one or a subset of those multiple activated SPS resource). Since configured scheduling resources of semi-persistently scheduling will have same characteristic (e.g., TB (Transport Block) size, MCS (Modulation and Coding Scheme), TTI length, numerology) and will periodically occur, it would be easy for the network to assure control information transmission. In one embodiment, the SPS resource could be activated by physical layer control signal or MAC control information or RRC signaling. The UE may need to reply SPS confirm message (e.g., SPS confirmation control information, acknowledgement, performs a transmission data from logical channel, etc.) for responding activating SPS. In one embodiment, the SPS resource could be only used for the control information transmission.

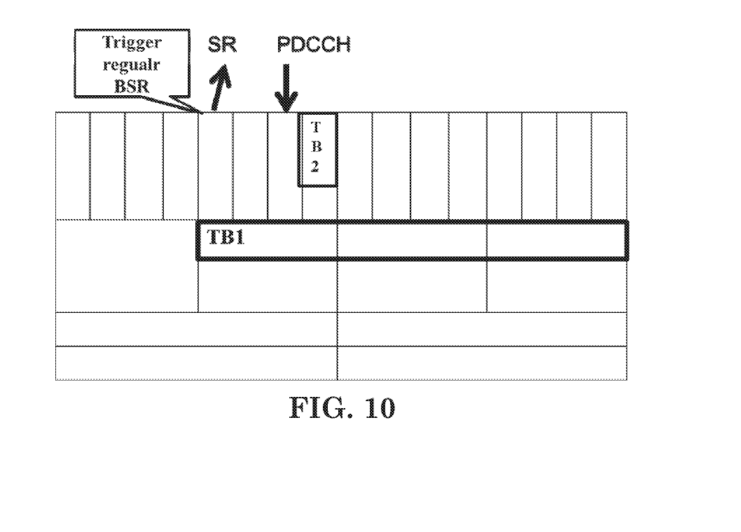

FIG. 10 illustrates an exemplary embodiment of Solution 1. In the example shown in FIG. 10, a regular BSR is triggered when there is available uplink data resource. However, since the available uplink data resource does not fit to the limitation of the BSR, the BSR will not be included into a transmission of the available uplink data resource and will trigger SR for requesting appropriate uplink data resource. After NW receives a SR, NW will understand there is a pending BSR in the UE. In addition, NW could schedule appropriate uplink data resource through downlink control signal, e.g., PDCCH (Physical Downlink Control Channel) signal. At last, the BSR will be included in the TB2 in FIG. 10 and sent to NW. Similarly, periodic BSR could have the same limitation. Since NW understands trigger timing of periodic BSR, NW can decide whether to allocate appropriate uplink data resource for UE to transmit the periodic BSR. Alternatively, a periodic BSR could have no limitation. Since NW understands trigger timing of periodic BSR and can decide scheduling order of uplink data resource, NW can control the periodic BSR (e.g., MAC control element for BSR, with exception of BSR included for padding) that is included into a transmission with certain limitation by scheduling the corresponding uplink resource in correct timing.

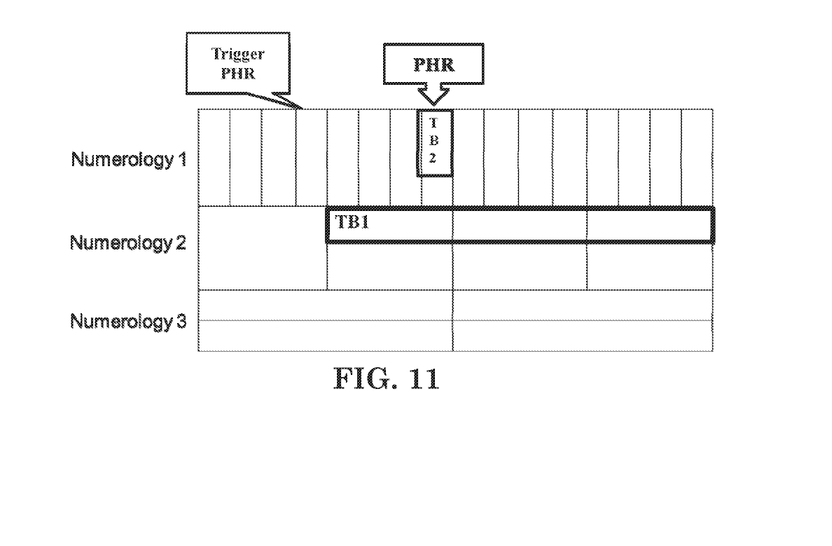

FIG. 11 illustrates another exemplary embodiment of Solution 1. In the example illustrated in FIG. 11, since PHR is linked to numerology 1, the transport block 1 (TB1) will not include the PHR control element even if there is a triggered PHR. After UE receives an uplink resource on numerology 1 for TB2 transmission, the UE will include a PHR control element into the TB2 transmission.

Moreover, in the case of event triggered control information (e.g., path-loss triggered PHR), since NW cannot predict occurrence of such control information, the UE may need to request appropriate uplink resource for transmission of such control information similar to legacy regular BSR mechanism. However, not every kind of event-triggered control information needs to be known immediately by NW when the event occurred. Therefore, the UE may need to request appropriate uplink resource for transmission of such control information with further condition. The condition could be there is at least one uplink transmission occurred in the same time. The condition could also be the UE not in power saving mode and/or inactive state. Furthermore, the condition could be UE not in DRX period. In one embodiment, the conditions mentioned above can be combined. Furthermore, the way for the UE requesting appropriate uplink resource could be sending SR and/or triggering regular BSR and/or sending RRC message and/or performing a random access procedure.

In one embodiment, different control information can apply different limitations (e.g., with different ranges, with or without limitation) in scheduling time unit aspect. For example, event-triggered BSR (e.g., regular BSR) could be limited to certain range of scheduling time unit, but periodically triggered BSR (e.g., periodic BSR) could have no limitation. As another example, BSR could be limited to a range of scheduling time units, but PHR could have no limitation.

As a further example, a BSR could be limited to a first range of scheduling time unit; and PHR could be limited to a second range of scheduling time unit. In addition, the first range could be different from the second range (partial overlapping or non-overlapping).

As an additional example, an event-triggered PHR could be limited to a first range of scheduling time unit; and a periodic PHR could be limited to a second range of scheduling time unit. In addition, the first range could be different from the second range (partial overlapping or non-overlapping).

As a further example, an event-triggered control information could be limited to a first range of scheduling time unit; and a periodic control information could be limited to a second range of scheduling time unit. In addition, the first range could be different from the second range (partial overlapping or non-overlapping).

Moreover, in one embodiment, the limitation could be provided through configuration received from NW. Furthermore, the limitation could be derived based on LCG (Logical Channel Group) with non-empty value or logical channel with data available for transmission, if the control information is for buffer status report. Alternatively, the limitation could be a predefined rule (e.g., follow current largest available sub-carrier spacing to the UE or follow reference numerology used to counting sub-frame).

In another alternative, the use inappropriate scheduling units to transmit control information could be prevented in order to achieve similar result. In one embodiment, the UE cannot use scheduling resource with TTI over a threshold to transmit control information in MAC layer. In one embodiment, the UE cannot use aggregated slots or extend slot to transmit control information in MAC layer. In one embodiment, the UE cannot use scheduling resource on certain numerology to transmit control information in MAC layer based on configuration from network or rule predefined in specification. In one embodiment, the UE cannot use scheduling resource on one or multiple physical channels for user data transmission, and/or on one or multiple cells.

In one embodiment, the information of scheduling unit preclusion could be predefined in the UE or could be configured by network through dedicated signaling or broadcast signaling.

Solution 2—The general concept of Solution 2 is to repeatedly include a triggered control information (e.g., MAC control element for the triggered control information) into different transmissions within a period to allow NW to possibly receive control information faster. Furthermore, it would be better if the different transmissions end in different timings. In one embodiment, if a UE already includes a triggered control information into a first transmission, the UE would not include the triggered control information (e.g., MAC control element for the triggered control information) into a second transmission, which will finish later than the first transmission, even if the triggered control information has not been cancelled.

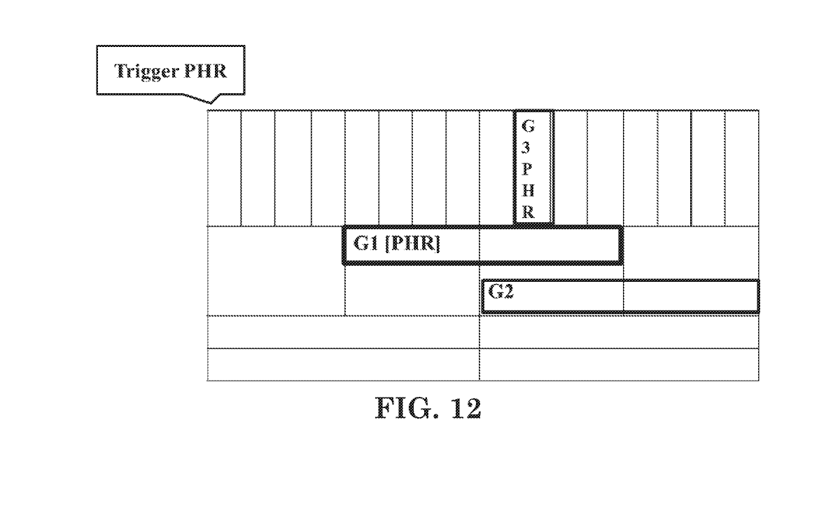

FIG. 12 illustrates exemplary options for Solution 2. As shown in FIG. 12, transmissions G1, G2, and G3 end in different timings. Furthermore, both transmissions G1 and G3 include PHR. However, the value of PHR in G1 and the value of PHR in G3 could be different. The UE could include PHR into G1 and G3 for the same triggered PHR (triggered by same event). Moreover, since G1 already includes a triggered PHR and G2 will end later than G1, the UE may not include the triggered PHR into G2. The values of the control information could be different for control information included in different transmissions. For example, values in the PHR in G1 could be different from values in the PHR in G3 even through those PHRs are triggered for same event (e.g., path loss over a threshold or periodic-timer expiration or etc.).

In general, there are multiple options to achieve Solution 2. Such multiple options could also be combined together to achieve Solution 2.

Option 1—In general, Option 1 involves modifying legacy cancellation rule of triggered control element. In LTE, generally, a triggered control information (e.g., BSR, PHR, SPS confirmation, etc.) will be cancelled when the control information is included into a MAC PDU. In Option 1, the cancellation rule could be modified such that a triggered control information will be cancelled when at least one transmission that includes the triggered control information is finished. Alternatively, the cancellation rule could be modified such that a triggered control information (e.g. a triggered PHR, a triggered BSR, or etc.) will be cancelled when at least one transmission, which includes such control information (e.g., MAC CE for PHR, MAC CE for BSR, with exception of BSR included for padding, or etc.) and occurs later than the control information is triggered, is finished. By this way, UE has no need to associate a triggered control information (e.g. regular BSR) with specific transmission(s) that includes the control information for deciding when to cancel the triggered control information

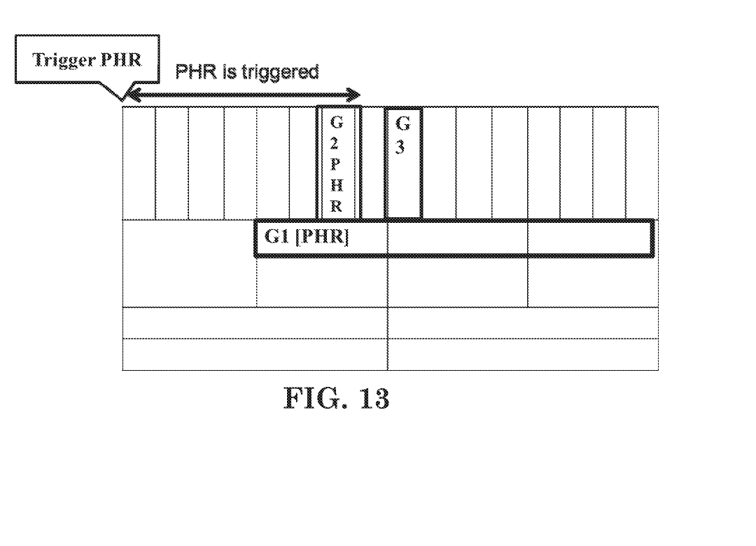

FIG. 13 shows an example involving PHR. In the example shown in FIG. 13, PHR is triggered earlier. When transmission G1 includes a MAC CE for PHR, the triggered PHR will not be cancelled. Rather, the triggered PHR would be cancelled when transmission of G1 is finished. However, since transmission G2 occurs before transmission G1 finish, transmission G2 will also include MAC CE for PHR based on Solution 2. The cancellation rule would also apply to transmission G2. Hence, when transmission G2 finishes, the triggered PHR would be cancelled, instead of till G1 finishing.

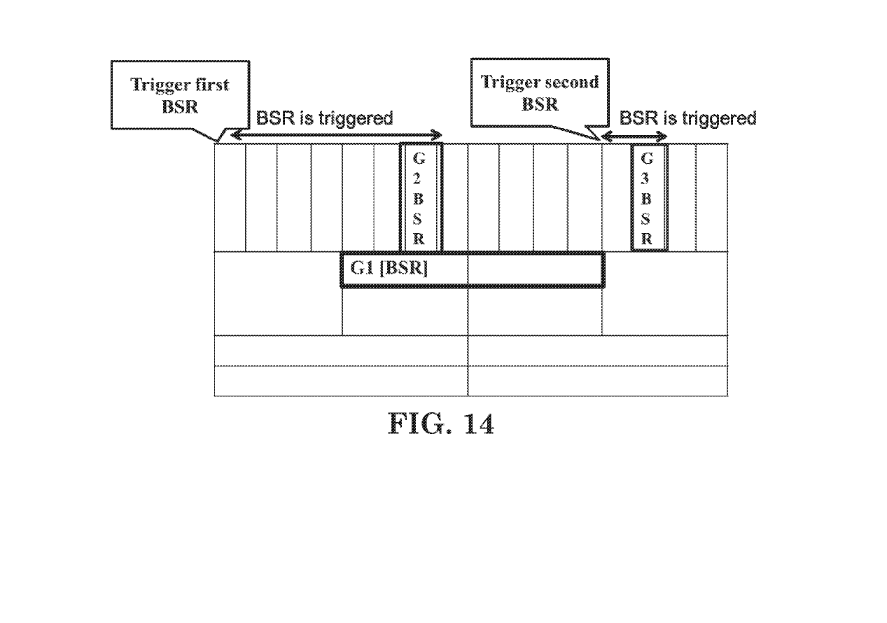

FIG. 14 illustrates an example involving BSR. In the example shown in FIG. 14, a first BSR is triggered and a MAC CE for the first BSR is included into transmission G1 and G2. After one of transmission G1 and G2 finish, the first triggered BSR will be cancelled. In the example, the first triggered BSR is cancelled when transmission G2 finishes. Afterward, a second BSR is triggered when transmission G1 finished. Since transmission G1 includes the MAC CE for the first triggered BSR instead of the second triggered BSR, the end of transmission G1 will not induce cancellation of the second triggered BSR. The second triggered BSR will be cancelled after it is included into the transmission G3 and the transmission G3 finishes.

Moreover, the control information has at least two different types, event triggered or periodic timer controlled. For the periodic timer controlled, since there is a timer for controlling whether to trigger control information, the timer should be handled carefully. To prevent unnecessary triggering, the condition for restarting the timer could be “if a control information has been triggered and not cancelled, and a transmission included the control information is finished”. More specifically, the timer could be re-started in closest next subframe if the timer unit is larger than the scheduling TTI or if the TTI ending is not aligned with subframe boundary.

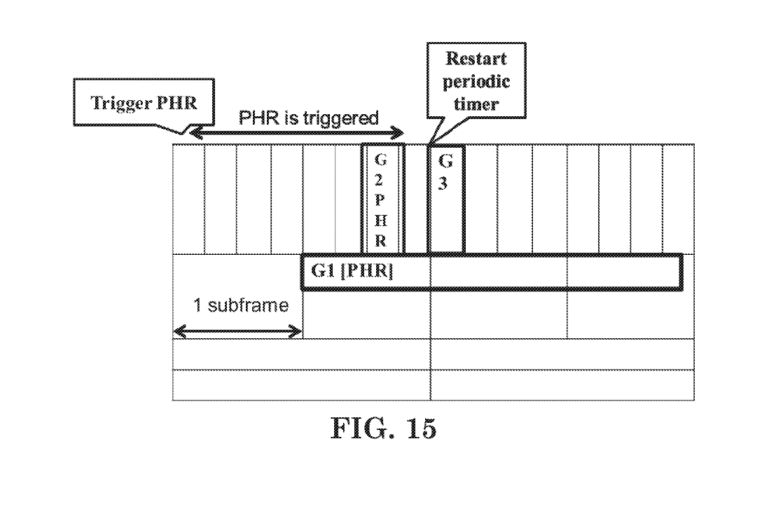

FIG. 15 illustrates an exemplary embodiment of periodic timer control of PHR. As shown in FIG. 15, after transmission G2 finishes, the periodic timer would restart at nearest next subframe. In addition, the SR (Scheduling Request) cancellation could be aligned with the cancellation rule mentioned above if the control information will also trigger SR.

Option 2: In general, Option 2 involves using a timer or counter to control. A new timer is defined for controlling when to cancel a triggered control information. The new timer could start when a control information is triggered, or when the control information is triggered and is included into a transmission. The triggered control information could exist until the new timer expired. Moreover, regarding periodically triggered control information, the timer for periodical triggering could be restarted after the new timer expired. The new timer value may be configurable or may be predefined (e.g., a subframe duration for reference numerology).

In one embodiment, if a new control element is triggered when the new timer is running, the new triggered control element may not be cancelled due to expiry of the new timer. Moreover, the new triggered control element may initiate another new timer or re-start current new timer when the condition for triggering new timer mentioned above is met.

In one embodiment, a counter could be used to count how many sub-frames passed since the control information has been triggered, or to count how many times a control information was included into a transmission since the control information has been triggered. The counter could be set to zero when a triggered control information is cancelled.

On the other hand, a UE could be scheduled with more than one transmissions that occur within the same timing. In such scenario, the UE could include a triggered control information into only one of the transmissions that occur within the same timing if those transmissions are scheduled by the same scheduler. By this way, if the control information has higher priority than data, redundant information and possible data delay are prevented. Moreover, since the control information would normally impact any later scheduling, it would be better to transmit control information as soon as possible.

Considering possible transmissions and retransmissions, if there are more than one transmission opportunities starting from same timing, it may be better for a UE to prioritize the transmission opportunity with shortest TTI. Alternatively, it may be better for a UE to prioritize the transmission opportunity with the highest transmission reliability.

Alternatively, the UE could include the triggered control information into multiple or all of those transmissions with same start timing for increasing reliability.

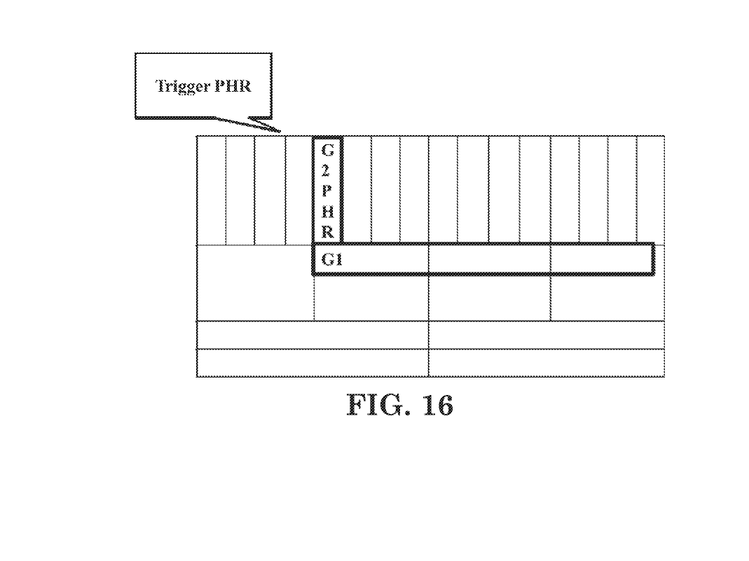

FIG. 16 illustrates an example in which the transmission with the shortest TTI is prioritized. In this example, a PHR is triggered earlier than scheduling and pending in the UE. Since both transmissions G1 and G2 will start at same time, the UE will prioritize transmission G2 for the PHR based on TTI consideration (G2 has shorter TTI).

In one embodiment, the control information discussed above could be a buffer status report. The buffer status report could be a regular BSR or a periodic BSR or a BSR MAC CE. In addition, the buffer status report could be a buffer status report dedicated for URLLC. In particular, the buffer status report could include the buffer status of a URLLC service (e.g., specific logical channel(s) has data available for transmission, specific LCG(s) has non-empty value).

In one embodiment, the control information discussed above could be a power headroom report. The power headroom report could be a periodic PHR or an event triggered PHR or a PHR MAC CE.

In one embodiment, the control information discussed above could be a semi-persistent confirmation. The control information discussed above could also be a beam information related report. The beam information related report could be UE beam(s) and NW beam(s) mapping information. The beam information related report could also be a beam measurement report. Furthermore, the beam information related report could be a qualified NW beam list (e.g., measurement over threshold). In addition, the beam information related report could be a TRP ID and/or beam ID report.

In one embodiment, the control information discussed above could be a numerology information related report. The numerology information related report could be a numerology measurement report, or a numerology capability report. The numerology information related report could also be a list of numerology index report.

In addition, different kinds of control information (e.g., BSR, PHR, event triggered, periodic triggered, etc.) could apply different solutions mentioned above.

In one embodiment, the UE could use one MAC entity for handling above issue related to multiple numerologies or different scheduling with different TTIs.

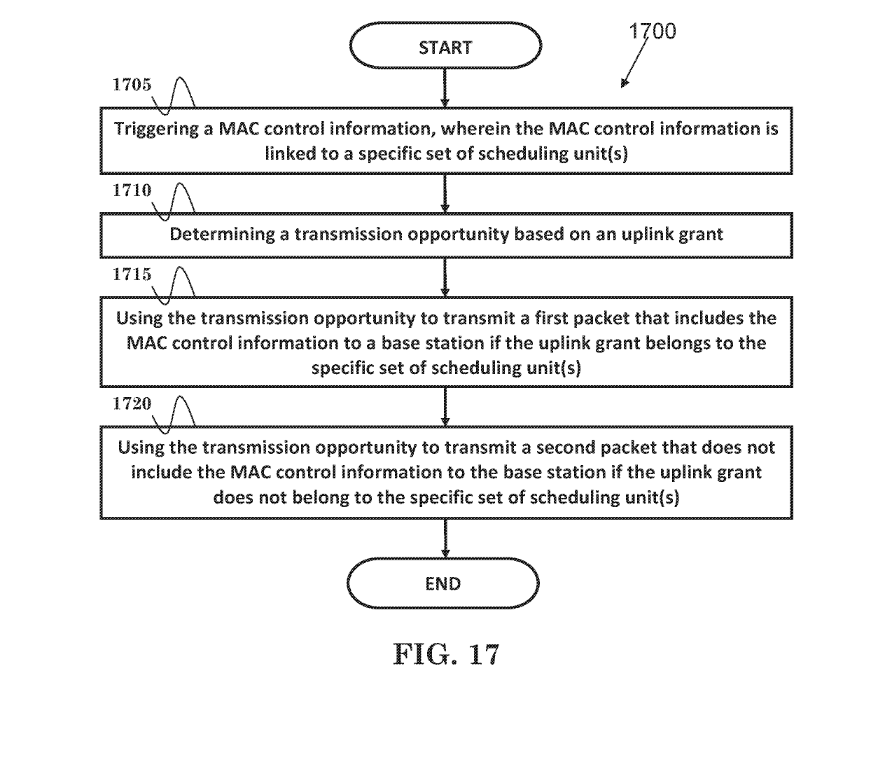

FIG. 17 is a flow chart 1700 according to one exemplary embodiment from the perspective of a UE. In step 1705, the UE triggers a MAC control information, wherein the MAC control information is linked to a specific set of scheduling unit(s). In step 1710, the UE determines a transmission opportunity based on an uplink grant. In step 1715, the UE uses the transmission opportunity to transmit a first packet that includes the MAC control information to a base station if the uplink grant belongs to the specific set of scheduling unit(s). In step 1720, the UE uses the transmission opportunity to transmit a second packet that does not include the MAC control information to the base station if the uplink grant does not belong to the specific set of scheduling unit(s).

In one embodiment, the specific set of scheduling unit(s) could be a range of Transmission Time Interval(s) (TTI). In addition, the specific set of scheduling units could be a set of numerology(ies). In particular, the specific set of scheduling unit(s) could be a range of symbols on specific numerology.

In one embodiment, the specific set of scheduling unit(s) could be a plurality of semi-persistent scheduling resources. The specific set of scheduling unit(s) could also be resources on a specific physical channel.

In one embodiment, the MAC control information could be a buffer status report (BSR) control information, or a power headroom report (PHR) control information. The MAC control information could also be a semi-persistent confirmation control information.

In one embodiment, the uplink grant could be used to indicate a radio resource for a data transmission opportunity. In addition, the uplink grant could be a configured uplink grant or an uplink grant received from network.

In one embodiment, the transmission opportunity could be determined based on an explicit field in the uplink grant. The explicit field could indicate one or multiple information as follows:
1. radio resource block(s) used by transmission (in frequency domain)
2. transmission start timing
3. transmission time interval
4. corresponding feedback timing
5. numerology used by the transmission
6. bandwidth part used by the transmission

Referring back to FIGS. 3 and 4, in one exemplary embodiment of a UE, the device 300 includes a program code 312 stored in the memory 310. The CPU 308 could execute program code 312 to enable the UE (i) to trigger a MAC control information, wherein the MAC control information is linked to a specific set of scheduling unit(s), (ii) to determine a transmission opportunity based on an uplink grant, (iii) to use the transmission opportunity to transmit a first packet that includes the MAC control information to a base station if the uplink grant belongs to the specific set of scheduling unit(s), and (iv) to use the transmission opportunity to transmit a second packet that does not include the MAC control information to the base station if the uplink grant does not belong to the specific set of scheduling unit(s). Furthermore, the CPU 308 can execute the program code 312 to perform all of the above-described actions and steps or others described herein.

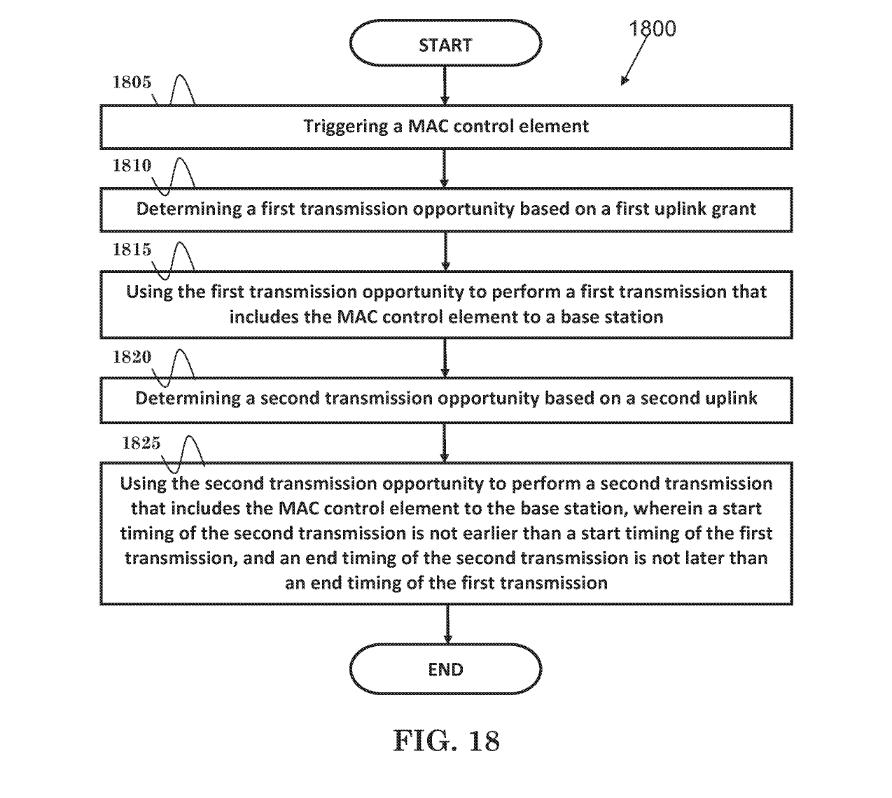

FIG. 18 is a flow chart 1800 according to one exemplary embodiment from the perspective of a UE. In step 1805, the UE triggers a MAC control element. In step 1810, the UE determines a first transmission opportunity based on a first uplink grant. In step 1815, the UE uses the first transmission opportunity to perform a first transmission that includes the MAC control element to a base station. In step 1820, the UE determines a second transmission opportunity based on a second uplink grant. In step 1825, the UE uses the second transmission opportunity to perform a second transmission that includes the MAC control element to the base station, wherein a start timing of the second transmission is not earlier than a start timing of the first transmission, and an end timing of the second transmission is not later than an end timing of the first transmission.

In one embodiment, the transmission of the first uplink grant and the transmission of the second uplink grant end in different timing. In one embodiment, the transmission of the first uplink grant and the transmission of the second uplink grant start from same timing.

In one embodiment, the value of the MAC control element in the first transmission could be the same as the value of the MAC control element in the second transmission. Alternatively, the value of the MAC control element in the first transmission could be different from the value of the MAC control element in the second transmission.

In one embodiment, the MAC control element could be a MAC control element for PHR. In another embodiment, the MAC control element could be a MAC control element for BSR, with the exception of the BSR included for padding. In another embodiment, the MAC control element could be a MAC control element for SPS confirmation. In another embodiment, the MAC control element could be a MAC control element for beam related report.

In one embodiment, the transmission of the first uplink grant and the transmission of the second uplink grant have different end timings.

In one embodiment, the first uplink grant could be different from the second uplink grant. In addition, the first uplink grant and/or the second uplink grant could be a configured uplink grant, or an uplink grant received from network (e.g., dynamic scheduling).

Referring back to FIGS. 3 and 4, in one exemplary embodiment of a UE, the device 300 includes a program code 312 stored in the memory 310. The CPU 308 could execute program code 312 (i) to trigger a MAC control element, (ii) to determine a first transmission opportunity based on a first uplink grant, (iii) to use the first transmission opportunity to perform a first transmission opportunity that includes the MAC control element to a base station, (iv) to determine a second transmission opportunity based on a second uplink grant, and (v) to use the second transmission opportunity to perform a second transmission that includes the MAC control information to the base station, wherein a start timing of the second transmission is not earlier than a start timing of the first transmission, and an end timing of the second transmission is not later than an end of the first transmission. Furthermore, the CPU 308 can execute the program code 312 to perform all of the above-described actions and steps or others described herein.

In the context of the embodiments discussed above, in general, a UE could be scheduled with more than one transmission that occurs within the same timing.

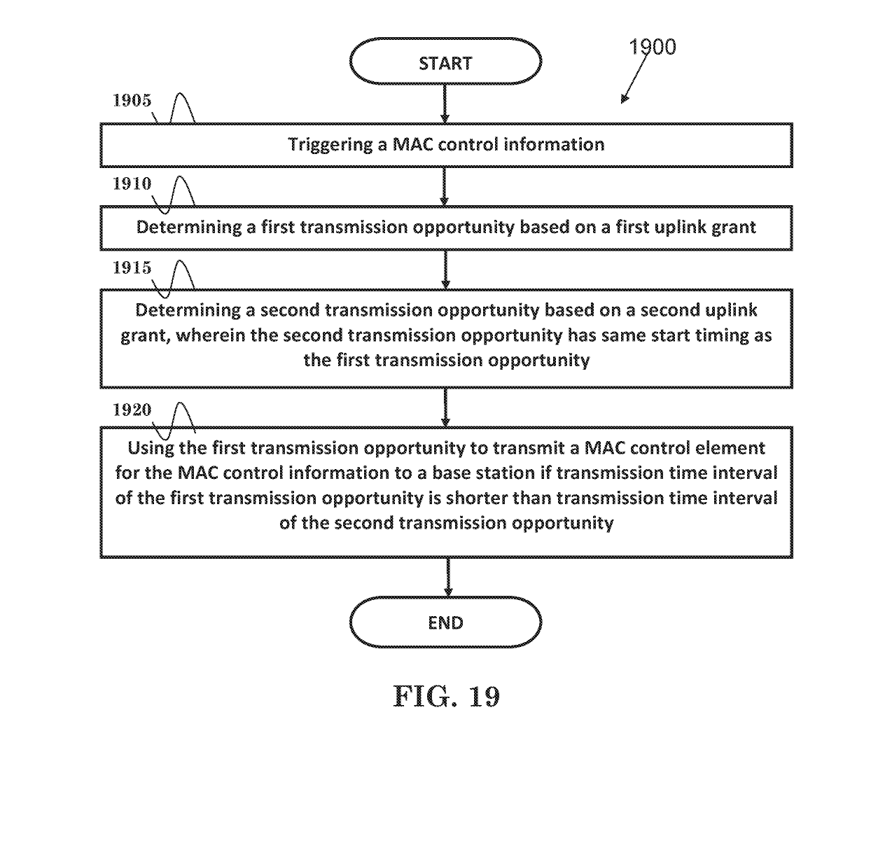

FIG. 19 is a flow chart 1900 according to one exemplary embodiment from the perspective of a UE. In step 1905, the UE triggers a MAC control information. In step 1910, the UE determines a first transmission opportunity based on a first uplink grant. In step 1915, the UE determines a second transmission opportunity based on a second uplink grant, wherein the second transmission opportunity has same start timing as the first transmission opportunity. In step 1920, the UE uses the first transmission opportunity to transmit a MAC control element for the MAC control information to a base station if transmission time interval of the first transmission opportunity is shorter than transmission time interval of the second transmission opportunity.

In one embodiment, the UE uses the second transmission opportunity to perform a transmission without the MAC control element to the base station. In one embodiment, the same start timing could be same subframe in time relation. In another embodiment, the same start timing is transmitting occur in the same time. In an alternative embodiment, the same start timing is that the base station will expect to receive transmission of the first transmission opportunity and transmission of the second transmission opportunity at the same time.

In one embodiment, the MAC control element could be a MAC control element for PHR. In another embodiment, the MAC control element could be a MAC control element for BSR, with exception of BSR included for padding. In another embodiment, the MAC control element could be a MAC control element for SPS confirmation. In an alternative embodiment, the MAC control element could be a MAC control element for beam related report.

In one embodiment, the MAC control information could be a PHR. In another embodiment, the MAC control information could be a regular BSR. In another embodiment, the MAC control information could be a periodic BSR. In another embodiment, the MAC control information could be a SPS confirmation. In another embodiment, the MAC control information could be a beam related control information.

Referring back to FIGS. 3 and 4, in one exemplary embodiment of a UE, the device 300 includes a program code 312 stored in the memory 310. The CPU 308 could execute program code 312 (i) to trigger a MAC control information, (ii) to determine a first transmission opportunity based on a first uplink grant, (iii) to determine a second transmission opportunity based on a second uplink grant, wherein the second transmission opportunity has same start timing as the first transmission opportunity, (iii) to use the first transmission opportunity to transmit a MAC control element for the MAC control information to a base station if transmission time interval of the first transmission opportunity is shorter than transmission time interval of the second transmission opportunity.

Still in the context of the embodiments illustrated in FIGS. 17, 18 and 19 and discussed above, the base station could be a TRP, a gNB, or an eNB. In one embodiment, the transmission opportunity could be a dedicated radio resource scheduled for the UE to perform transmission. In particular, the first transmission opportunity and the second transmission opportunity could be dedicated radio resources scheduled for the UE to perform transmissions.

In one embodiment, the transmission opportunity could be determined based on an explicit field in the uplink grant and/or implicitly based on a reception timing of the uplink grant. In particular, the first transmission opportunity could be determined based on an explicit field in the first uplink grant or implicitly based on a reception timing of the first uplink grant. Similarly, the second transmission opportunity could be determined based on an explicit field in the second uplink grant or implicitly based on a reception timing of the second uplink grant. In one embodiment, the explicit field could indicate radio resource block(s) used by transmission and/or transmission start timing and/or transmission time interval and/or corresponding feedback timing.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a UE (User Equipment) for handling MAC (Medium Access Control) control information transmission, comprising:
triggering a MAC control information, wherein the MAC control information is linked to a specific set of scheduling unit(s);
determining a transmission opportunity based on an uplink grant;
using the transmission opportunity to transmit a first packet that includes the MAC control information to a base station if the uplink grant belongs to the specific set of scheduling unit(s); and
using the transmission opportunity to transmit a second packet that does not include the MAC control information to the base station if the uplink grant does not belong to the specific set of scheduling unit(s).

2. The method of claim 1, wherein the specific set of scheduling unit(s) is a range of Transmission Time Interval(s) (TTI).

3. The method of claim 1, wherein the specific set of scheduling unit(s) is a set of numerology(ies).

4. The method of claim 1, wherein the specific set of scheduling unit(s) is a plurality of semi-persistent scheduling resources.

5. The method of claim 1, wherein the MAC control information is a MAC control element for buffer status report, a MAC control element for power headroom report, a MAC control element for SPS confirmation, or a MAC control element for beam related report.

6. The method of claim 1, wherein the transmission opportunity is determined based on an explicit field in the uplink grant.

7. The method of claim 6, wherein the explicit field indicates radio resource block(s), a transmission start timing, a transmission time interval, and/or a corresponding feedback timing.

8. A method of a UE (User Equipment) for handling MAC (Medium Access Control) control element transmission, comprising:
triggering a MAC control information;
determining a first transmission opportunity based on a first uplink grant;
determining a second transmission opportunity based on a second uplink grant, wherein the second transmission opportunity has same start timing as the first transmission opportunity; and
using the first transmission opportunity to transmit a MAC control element for the MAC control information to a base station if transmission time interval of the first transmission opportunity is shorter than transmission time interval of the second transmission opportunity.

9. The method of claim 8, further comprising: the UE uses the second transmission opportunity to perform a transmission without the MAC control element to the base station.

10. The method of claim 8, wherein the MAC control element is a MAC control element for buffer status report, with exception of BSR included for padding, or a MAC control element for power headroom report, or a MAC control element for SPS confirmation, or a MAC control element for beam related report.

11. The method of claim 8, wherein the MAC control information is a PHR, a regular BSR, a periodic BSR, a SPS confirmation, or a beam related control information.

12. A User Equipment (UE), comprising:
a control circuit;
a processor installed in the control circuit; and
a memory installed in the control circuit and operatively coupled to the processor;
wherein the processor is configured to execute a program code stored in the memory to:
trigger a MAC control information, wherein the MAC control information is linked to a specific set of scheduling unit(s);
determine a transmission opportunity based on an uplink grant;
use the transmission opportunity to transmit a first packet that includes the MAC control information to a base station if the uplink grant belongs to the specific set of scheduling unit(s); and
use the transmission opportunity to transmit a second packet that does not include the MAC control information to the base station if the uplink grant does not belong to the specific set of scheduling unit(s).

13. The UE of claim 12, wherein the specific set of scheduling unit(s) is a range of Transmission Time Interval(s) (TTI).

14. The UE of claim 12, wherein the specific set of scheduling unit(s) is a set of numerology(ies).

15. The UE of claim 12, wherein the specific set of scheduling unit(s) is a plurality of semi-persistent scheduling resources.

16. The UE of claim 12, wherein the MAC control information is a MAC control element for buffer status report, a MAC control element for power headroom report, a MAC control element for SPS confirmation, or a MAC control element for beam related report.

17. The UE of claim 12, wherein the transmission opportunity is determined based on an explicit field in the uplink grant.

18. The method of claim 17, wherein the explicit field indicates radio resource block(s), a transmission start timing, a transmission time interval, and/or a corresponding feedback timing.
